(19) United States
(12) Patent Application Publication
(10) Pub. No.: US 2018/0083530 A1
(43) Pub. Date: Mar. 22, 2018

(54) POWER SUPPLY CIRCUIT AND POWER SUPPLY DEVICE

(71) Applicant: KABUSHIKI KAISHA TOSHIBA, Minato-ku (JP)

(72) Inventor: Takeshi UENO, Kawasaki (JP)

(73) Assignee: KABUSHIKI KAISHA TOSHIBA, Minato-ku (JP)

(21) Appl. No.: 15/427,300

(22) Filed: Feb. 8, 2017

(30) Foreign Application Priority Data
Sep. 16, 2016 (JP) 2016-181788

(51) Int. Cl. H02M 3/07; H02M 7/06; H02M 1/088

(52) U.S. Cl. CPC H02M 3/07; H02M 2001/0048; H02M 1/088; H02M 7/06

(57) ABSTRACT

According to one embodiment, a power supply circuit includes: a first capacitor configured to accumulate an electric charge corresponding to an input voltage; an n-number of second capacitors configured to be connected in parallel to the first capacitor, n being an integer equal to or larger than 1); an n-number of switches configured to be respectively connected in series to the n-number of second capacitors; a DC-DC converter configured to step down the input voltage; and a control circuit configured to perform control to sequentially turn on the switches each time the input voltage reaches a first threshold voltage.

### CROSS-REFERENCE TO RELATED APPLICATIONS

This application is based upon and claims the benefit of priority from Japanese Patent Application No. 2016-181788, filed on Sep. 16, 2016; the entire contents of which are incorporated herein by reference.

### FIELD

Embodiments of the present invention pertain to a power supply circuit and a power supply device.

### BACKGROUND

Known is a technology called energy harvesting to convert a weak energy in an environment into an electric energy by a power generation element instanced by a solar battery, a thermoelectric power generation element or a piezoelectric element. In this technology, electric power outputted by the power generation element largely varies depending on an environmental condition. Such being the case, a configuration for temporarily accumulating the electric power generated by the power generation element in a capacitance is used for buffering a variation of the electric power depending on the environmental condition. A configuration for monitoring an amount of the power generation of the power generation element and a residual amount of the accumulated electric power is also used for improving power accumulation efficiency and an efficient use of energy of the accumulated electric power.

Such an example is proposed as a related technology that individual capacitances are prepared per load circuit, charges for the individual capacitances are prioritized, and the load having a higher priority level is started up in a short period of time.

The related technology described above involves monitoring the charging voltages of the plurality of capacitances, and selecting the capacitance that is to be charged with the electricity. In this case, it is necessary to monitor voltages corresponding to a number of capacitances. This therefore results in increases in circuit scale and in power consumption.

### BRIEF DESCRIPTION OF THE DRAWINGS

FIG. 1 is a circuit diagram illustrating a basic configuration of a power supply device according to a first embodiment;

FIG. 2 is a diagram illustrating waveforms of respective voltages in FIG. 1;

FIG. 3 is a circuit diagram illustrating an example of a specific configuration of a control circuit in FIG. 1;

FIG. 4 is a diagram illustrating waveforms of the respective voltages in FIG. 3;

FIG. 5 is a circuit diagram of the power supply device according to a third embodiment; and

FIG. 6 is a diagram illustrating waveforms of the respective voltages in FIG. 5.

### DETAILED DESCRIPTION

According to one embodiment, a power supply circuit includes: a first capacitor configured to accumulate an electric charge corresponding to an input voltage; an n-number of second capacitors configured to be connected in parallel to the first capacitor, n being an integer equal to or larger than 1); an n-number of switches configured to be respectively connected in series to the n-number of second capacitors; a DC-DC converter configured to step down the input voltage; and a control circuit configured to perform control to sequentially turn on the switches each time the input voltage reaches a first threshold voltage.

Embodiments of the present invention will hereinafter be described with reference to the drawings.

### First Embodiment

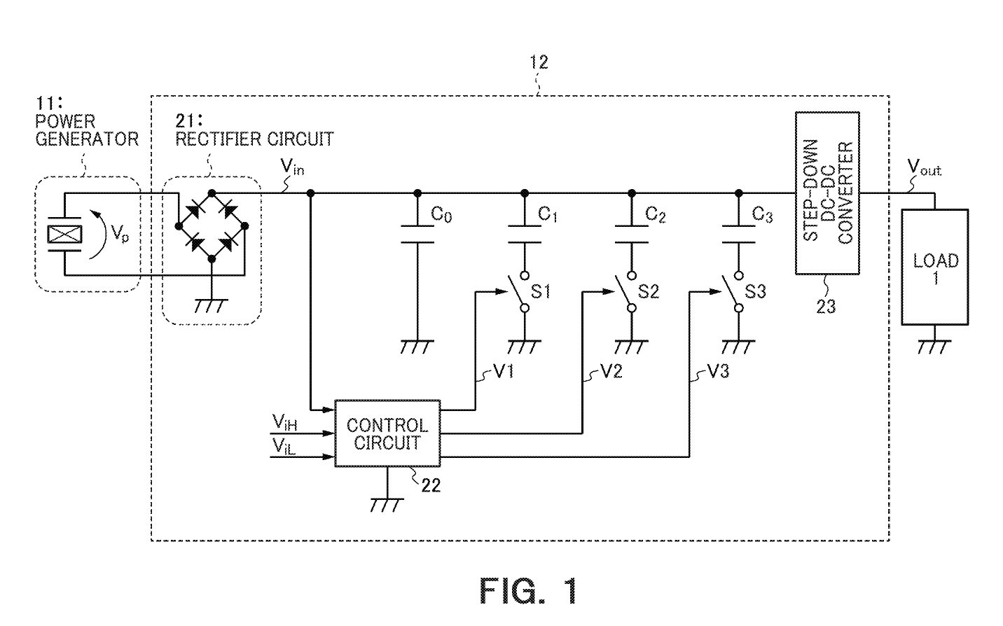

FIG. 1 is a circuit diagram illustrating an example of a configuration of a power supply device according to the first embodiment. As illustrated in FIG. 1, the power supply device includes a power generator 11 and a power supply circuit 12. The power supply circuit 12 includes a rectifier circuit 21, a plurality of capacitors C₀-C₃, switches S1-S3, a control circuit 22, and a step-down DC-DC converter 23. An output terminal of the step-down DC-DC converter (which will hereinafter be simply referred to as the DC-DC converter) 23 is connected to a load 1. Voltages (input voltages Vᵢₙ) of the capacitors C₀-C₃ are converted by the DC-DC converter 23 into low voltages Vₒᵤₜ, and the voltages Vₒᵤₜ are supplied to the load 1.

The power generator 11 is equipped with a circuit including a power generation element instanced by a solar battery, a thermoelectric power generation element or a piezoelectric element. FIG. 1 illustrates an example of using the piezoelectric element as the power generation element. The piezoelectric element generates an alternate current (AC) voltage Vₚ by applying vibrations to the piezoelectric element. The generation voltage Vₚ is converted by the rectifier circuit 21 into a direct current (DC), and the rectifier circuit 21 outputs the post-converting voltage as the input voltage Vᵢₙ. The solar battery or the thermoelectric power generation element is used as the power generation element, in which case the power generation element outputs the DC voltage, and hence the rectifier circuit is not required. Any inconvenience may not be caused by taking such an arbitrary configuration of the rectifier circuit 21 as a diode bridge. FIG. 1 illustrates an example of the diode bridge.

The capacitor C₀ is connected to between an output terminal of the rectifier circuit 21 and a ground. The capacitors C₁-C₃ are connected respectively in parallel with the capacitor C₀. One ends of the capacitors C₁-C₃ are electrically connected respectively to the output terminal of the rectifier circuit 21. The other ends of the capacitors C₁-C₃ are connected respectively to ground terminals via the switches S1-S3. The capacitors C₁-C₃ are assumed to have a same capacitance. A number of the capacitors connected in parallel to the capacitor C₀ is herein “3” and may also be an integer equal to or larger than “1”.

The switches S1-S3 are controlled by control voltages V1-V3 supplied from the control circuit 22. When the control voltages V1, V2, V3 are at a low level (which will hereinafter be simply termed Low), the switches S1, S2, S3 are in an off state. When the control voltages V1, V2, V3 are at a high level (which will hereinafter be simply termed High), the switches S1, S2, S3 are in an on state. Each of the switches S1-S3 is kept off in an initial state. Use and non-use of the capacitors C₁-C₃ are changed over by switching over the on/off states of these switches S1-S3. As a result, capacitance values between the input terminal of the DC-DC converter 23 and the ground terminals are changed over. The switches S1-S3 are configured by Metal Oxide Semiconductor (MOS) transistors by way of one example. However, the configuration of each of the switches S1-S3 is not limited to the MOS transistor.

The control circuit 22 monitors the input voltage (capacitor charging voltage) Vᵢₙ outputted from the rectifier circuit 21. The control circuit 22 compares the input voltage Vᵢₙ with a first threshold voltage V_{H} and a second threshold voltage V_{iL}, which are supplied from an external circuit. The control circuit 22 generates, based on comparative results, the control voltages V1, V2, V3, and outputs these control voltages V1, V2, V3. To be specific, the control circuit 22 sequentially sets on the control voltages V1, V2, V3 each time the input voltage Vᵢₙ reaches the first threshold voltage V_{iH} (the input voltage Vᵢₙ exceeds the first threshold voltage V_{iH}). In other words, the control circuit 22 sequentially turns on the switches S1-S3 each time the input voltage Vᵢₙ reaches the first threshold voltage V_{iH}. The control circuit 22 turns off all of the switches S1-S3 when the input voltage Vᵢₙ becomes smaller than the second threshold voltage V_{iL}.

Herein, the first threshold voltage V_{iH} is higher than the second threshold voltage V_{iL}. The first threshold voltage V_{iH} is determined corresponding to a withstand voltage of the DC-DC converter 23. The second threshold voltage V_{iL} is equal to or larger than a lowest operation voltage (which is the lowest voltage for the DC-DC converter 23 to start operating) V_{UVLO}.

The DC-DC converter 23 steps down the input voltage (capacitor charging voltage) Vin outputted from the rectifier circuit 21. In other words, the DC-DC converter 23 steps down the voltages of the capacitors C₁-C₃. The DC-DC converter 23 thus generates an output voltage Vₒᵤₜ. The DC-DC converter 23 supplies the output voltage Vₒᵤₜ to the load 1.

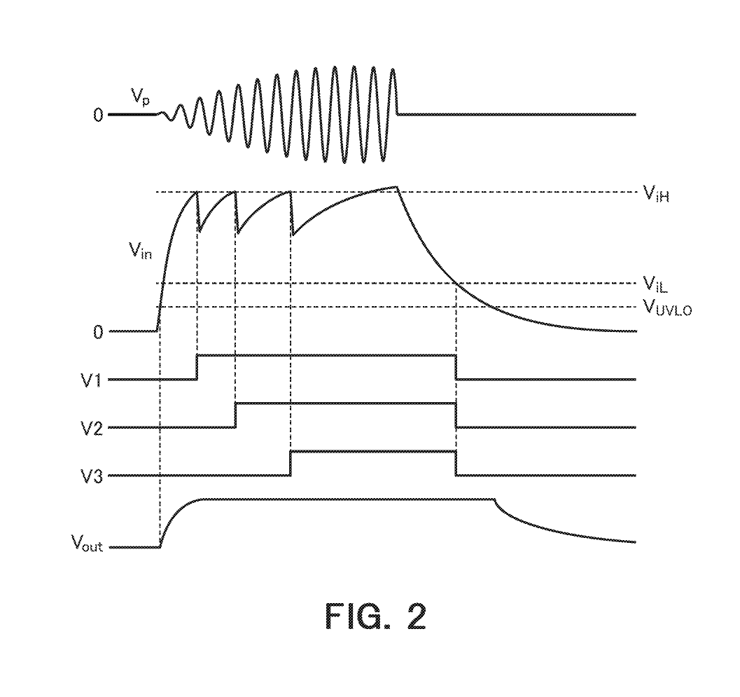

FIG. 2 illustrates one example of operation waveforms of respective units of the power supply device depicted in FIG. 1. When the input voltage Vᵢₙ is lower than the second threshold voltage V_{iL}, the control circuit 22 outputs the control voltages V1-V3 each taking the Low level. The piezoelectric element of the power generator 11 generates the generation voltage Vₚ in this state, at which time the generation voltage Vₚ is converted by the rectifier circuit 21 into the voltage Vᵢₙ, and the capacitor C₀ starts being charged with the electricity. The switches S1-S3 are off, and hence the capacitors C₁-C₃ are not charged with the electricity. Consequently, the input voltage (capacitance charging voltage) Vᵢₙ rises fast. When the input voltage Vᵢₙ reaches the lowest operation voltage V_{UVLO} of the DC-DC converter 23, the DC-DC converter 23 starts operating. The DC-DC converter 23, which has started operating, supplies the output voltage Vₒᵤₜ to the load 1.

Thereafter, when the input voltage Vᵢₙ reaches the first threshold voltage V_{iH}, the control circuit 22 sets High the control voltage V1. The switch S1 thereby transitions to the on-state from the off-state, and the capacitor C₁ is therefore connected in parallel to the capacitor C₀. When the capacitor C₁ is connected in parallel, part of electric charge applied to the capacitor C₀ is transferred to the capacitor C₁, and the input voltage Vᵢₙ therefore temporarily drops down. The capacitors C₀, C₁ are substantially the same in their capacitances, and are therefore the same or substantially the same in their electric charge.

It is herein assumed that the following Mathematical Expression 1 is satisfied:

$$\begin{matrix}[ Mathematical Expression 1 ] & \\ {C}_{1} < {C}_{0} \frac{{V}_{iH} - {V}_{UVLO}}{{V}_{UVLO}} & ( 1 )\end{matrix}$$

When the control voltage V1 becomes High (when the switch S1 is turned on), the input voltage Vᵢₙ is kept larger than the lowest operation voltage V_{UVLO}. Hence, the DC-DC converter 23 continues operating, and the output voltage Vₒᵤₜ supplied to the load 1 is constant.

Next, when the input voltage Vᵢₙ reaches again the first threshold voltage V_{iH}, the control circuit 22 sets High the control voltage V2. The capacitor C₂ is thereby connected in parallel to the capacitor C₀. When the capacitor C₂ is connected in parallel, part of the electric charges applied to the capacitors C₀, C₁ are transferred to the capacitor C₂, and therefore the input voltage Vᵢₙ temporarily drops. The capacitors C₀-C₂ are the same in their capacitances, and are therefore the same or substantially the same in their electric charge.

It is herein assumed that the following Mathematical Expression 2 is satisfied:

$$\begin{matrix}[ Mathematical Expression 2 ] & \\ {C}_{2} < {C}_{0} \frac{{V}_{iH} - {V}_{UVLO}}{{V}_{UVLO}} + {C}_{1} \frac{{V}_{iH} - {V}_{UVLO}}{{V}_{UVLO}} & ( 2 )\end{matrix}$$

When the control voltage V2 becomes High (when the switch S2 is turned on), the input voltage Vᵢₙ is kept larger than the lowest operation voltage V_{UVLO}. Therefore, the DC-DC converter 23 continues operating, and the output voltage Vₒᵤₜ supplied to the load 1 is constant.

Next, when the input voltage Vᵢₙ reaches again the first threshold voltage V_{iH}, the control circuit 22 sets High the control voltage V3. The capacitor C₃ is thereby connected in parallel to the capacitor C₀. When the capacitor C₃ is connected in parallel, part of the electric charges applied to the capacitors C₀-C₂ are transferred to the capacitor C₃, and therefore the input voltage Vᵢₙ temporarily drops. The capacitors C₀-C₃ are the same in their capacitances, and therefore the capacitors C₀, C₁, C₂, C₃ are the same or substantially the same in their electric charge.

It is herein assumed that the following Mathematical Expression 3 is satisfied:

$$\begin{matrix}[ Mathematical Expression 3 ] & \\ {C}_{3} < {C}_{0} \frac{{V}_{iH} - {V}_{UVLO}}{{V}_{UVLO}} + {C}_{1} \frac{{V}_{iH} - {V}_{UVLO}}{{V}_{UVLO}} + {C}_{2} \frac{{V}_{iH} - {V}_{UVLO}}{{V}_{UVLO}} & ( 3 )\end{matrix}$$

When the control voltage V3 becomes High (when the switch S3 is turned on), the input voltage Vᵢₙ is kept larger than the lowest operation voltage V_{UVLO}. Hence, the DC-DC converter 23 continues operating, and the output voltage Vₒᵤₜ supplied to the load 1 is constant.

As described above, each time the input voltage Vᵢₙ reaches the first threshold voltage V_{iH}, the capacitors C₁-C₃ are sequentially connected in parallel to the capacitor C₀.

Herein, when the Mathematical Expressions (1)-(3) are generalized with respect to a capacitance value Cᵢ₊₁ (i is an integer equal to or larger than “0”) of an (i+1)th capacitor, this can be expressed by the following Mathematical Expression 4:

$$\begin{matrix}[ Mathematical Expression 4 ] & \\ {C}_{i + 1} < {\sum }_{j = 0}^{i} {C}_{j} \frac{{V}_{iH} - {V}_{UVLO}}{{V}_{UVLO}} & ( 4 )\end{matrix}$$

When this Mathematical Expression (4) is satisfied, a relationship of Vin>V_{UVLO} is established, and hence the DC-DC converter 23 continues operating, during which the capacitance value to retain the input voltage Vᵢₙ can be stepwise increased, thereby enabling a larger amount of energy to be accumulated.

It is assumed that a certain length of time elapses after turning on the switch S3, and the voltage Vₚ generated by the power generator 11 drops down. At this time, the input voltage Vᵢₙ inputted from the rectifier circuit 21 gradually drops. As a result, the input voltage Vᵢₙ drops under the second threshold voltage V_{iL}, at which time the control circuit 22 detects this decrease and set Low all of the control voltages V1-V3. All of the switches S1-S3 are thereby turned off. Consequently, the operation returns to the initial state in which only the capacitor C₀ is connected to the power generator 11. Even in the case of the drop-down of the generation voltage of the power generator 11, it is thereby feasible to reduce a period of time for which the DC-DC converter 23 keeps stopping. Further, the voltage generated by the power generator 11 rises next time, in which case the DC-DC converter 23 can be started at a high speed.

As described above, according to the first embodiment, the capacitors C₁-C₃ are sequentially connected in parallel to the capacitor C₀, whereby the capacitance values between the input terminal of the DC-DC converter 23 and the ground terminals can be gradually increased. It is thereby possible to make compatible both of the high-speed startup of the DC-DC converter 23 and the large capacity power storage on the input side of the DC-DC converter 23. At this time, the voltage required to be observed by the control circuit 22 is only the input voltage Vᵢₙ of the DC-DC converter 23, and hence it is feasible to reduce a planar dimension and power consumption of the control circuit 22.

### Second Embodiment

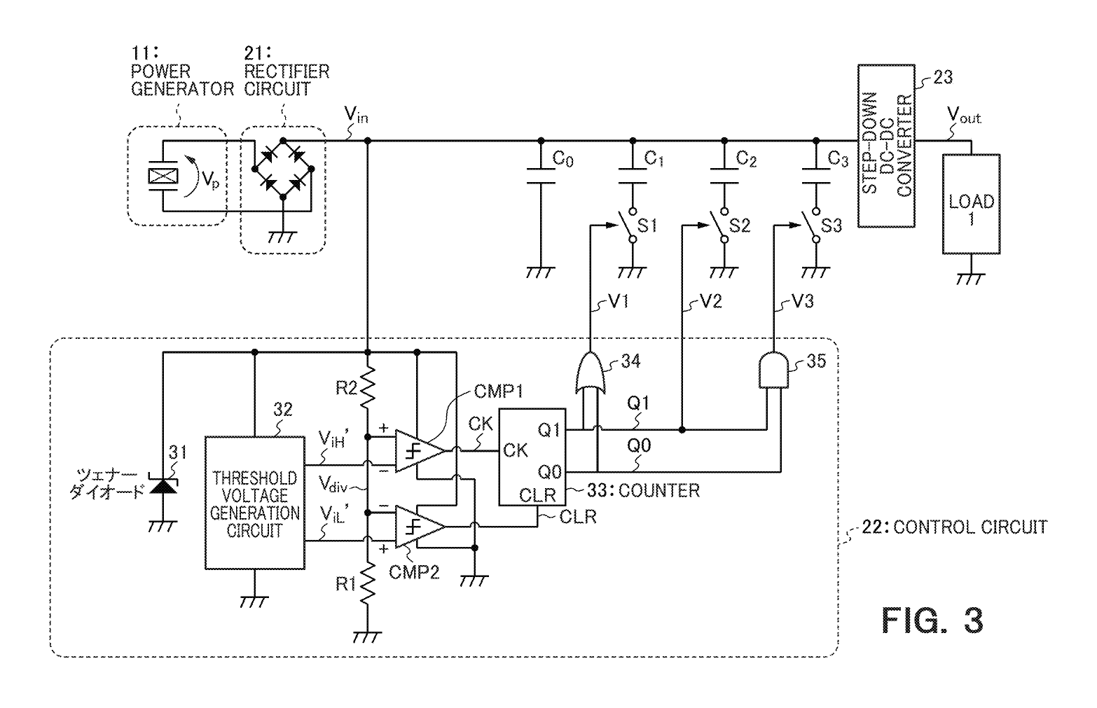

FIG. 3 is a diagram illustrating a specific example of the control circuit 22 in the configuration of FIG. 1.

The control circuit 22 includes a Zener diode 31, a threshold voltage generation circuit 32, a resistance R1, a resistance R2, comparators CMP1, CMP2, a counter 33, and OR circuit 34, and an AND circuit 35.

The control circuit 22 operates, with the input voltage Vᵢₙ being used as the power source. Note that the counter 33, the OR circuit 34 and the AND circuit 35, though none of their power sources are illustrated in FIG. 3, are each driven by the input voltage Vᵢₙ.

The Zener diode 31 is a constant voltage circuit that restricts the input voltage Vᵢₙ to a predetermined upper limit value. When a constant or larger level of voltage is applied to the control circuit 22, the Zener diode 31 operates to flow an overcurrent to the ground terminal, thus restricting the input voltage Vᵢₙ. The overcurrent is thereby prevented from being applied to the control circuit 22. A shunt regulator may also be employed as a substitute for the Zener diode.

The threshold voltage generation circuit 32 is driven by the input voltage Vᵢₙ, and outputs a predetermined first threshold voltage V_{iH}′ and a predetermined second threshold voltage V_{iL}′, respectively.

An output terminal of the rectifier circuit 21 is connected to the ground terminal via the resistance R2 and the resistance R1. The input voltage Vᵢₙ is divided by the resistance R2 and the resistance R1, and a voltage (divided voltage) V_{div} at a connecting point between the resistance R1 and the resistance R2 is supplied to the comparators CMP1, CMP2. Herein, a relationship between the divided voltage V_{div} and the input voltage Vᵢₙ is expressed as follows.

$$\begin{matrix}[ Mathematical Expression 5 ] & \\ {V}_{div} = \frac{{R}_{1}}{{R}_{1} + {R}_{2}} {V}_{i n} & ( 5 )\end{matrix}$$

The comparator CMP1 compares the first threshold voltage V_{iH}′ with the divided voltage V_{div}, and outputs a signal CK. The signal CK is High when the divided voltage V_{div} is equal to or larger than the first threshold voltage V_{iH}′, but is Low when the divided voltage V_{div} is smaller than the first threshold voltage V_{iH}′. The signal CK is inputted to a CK terminal of the counter 33.

The comparator CMP2 compares the second threshold voltage V_{iL}′ with the divided voltage V_{div}, and outputs a signal CLR. The signal CLR is High when the divided voltage V_{div} is smaller than the second threshold voltage V_{iL}′, but is Low when the divided voltage V_{div} is equal to or larger than the second threshold voltage V_{iL}′. The signal CLR is inputted to a CLR terminal of the counter 33.

The counter 33 counts up the output each time the signal CK varies to High from Low. The counter 33 includes output terminals Q0, Q1, and outputs signals (taking the High or Low level) from the output terminals Q0, Q1 according to the count value.

In the initial state (in which the signal CK and the signal CLR are in any Low state), outputs of the output terminals Q0, Q1 are given such as (Q0, Q1)=(0, 0). Thereafter, whenever counted up, i.e., each time the signal CK varies to High from Low, the outputs of the output terminals Q0, Q1 vary to (1, 0), (0, 0), (1, 1) in this sequence. A digit “0” represents Low. A digit “1” represents High.

The counter 33 resets a count value when the signal CLR varies to High from Low. In other words, the outputs become (Q0, Q1)=(0, 0).

The OR circuit 34, which is connected to the output terminals Q0, Q1, generates the control voltage V1 corresponding to signals of the output terminals Q0, Q1, and outputs the control voltage V1 to the switch S1. The AND circuit 35, which is also connected to the output terminals Q0, Q1, generates the control voltage V3 corresponding to signals of the output terminals Q0, Q1, and outputs the control voltage V3 to the switch S3. The signal of the terminal Q1 is given as the control voltage V2 to the switch S2.

Hence, when (Q0, Q1)=(0, 0), each of the control voltages V1, V2, V3 is Low; and when (Q0, Q1)=(1, 0) at a first count-up, the control voltage V1 is High, while the control voltages V2, V3 are Low. When (Q0, Q1)=(0, 1) at the next count-up, the control voltages V1, V2 are High, while th control voltage V3 is Low. When (Q0, Q1)=(1, 1) at the subsequent count-up, the control values V1, V2, V3 are all High.

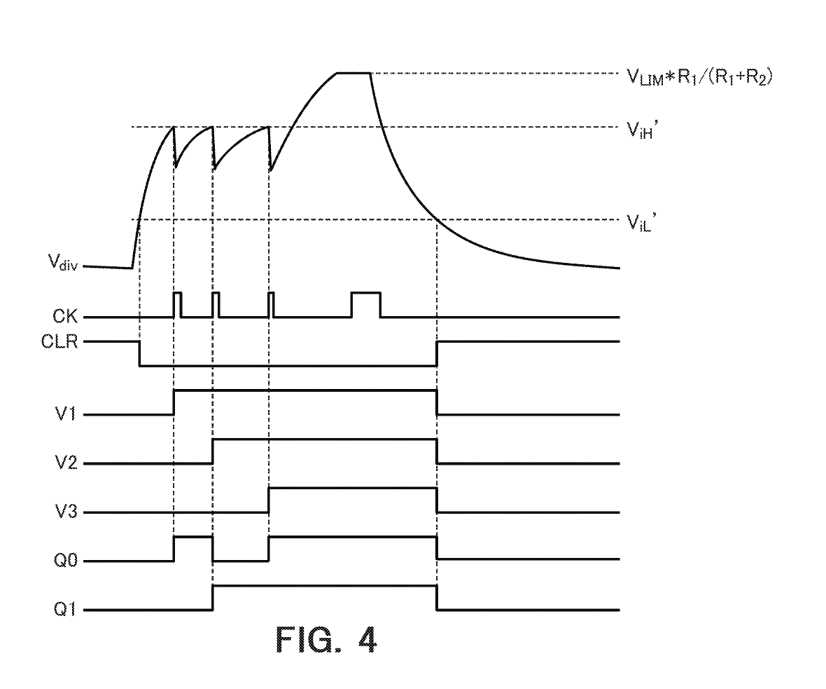

FIG. 4 is a diagram illustrating waveforms of the divided voltage V_{div}, the signal CK, the signal CLR, the control values V1, V2, V3, and the signals Q0, Q1.

Each time the divided voltage V_{div} reaches the first threshold voltage V_{iH}′, the output of the counter 33 is counted up, and the control values V1-V3 sequentially become High. When a relationship of the divided voltage V_{div}<the second threshold voltage V_{iL}′ is established, the counter 33 is reset, and the control values V1-V3 become Low simultaneously. Let V_{LIM} be a Zener voltage (an upper limit value of the capacitor charging voltage), an upper limit of the divided voltage V_{div} is expressed such as:

$$\begin{matrix}[ Mathematical Expression 6 ] \\ \frac{{R}_{1}}{{R}_{1} + {R}_{2}} {V}_{L IM}\end{matrix}$$

Herein, V_{iH}′ and V_{iL}′ are expressed as follows.

$$\begin{matrix}[ Mathematical Expression 7 ] & \\ {V}_{iH}^{′} = \frac{{R}_{1}}{{R}_{1} + {R}_{2}} {V}_{iH} & ( 6 ) \\ {V}_{iL}^{′} = \frac{{R}_{1}}{{R}_{1} + {R}_{2}} {V}_{iL} & ( 7 )\end{matrix}$$

When the switches S1-S3 are turned on/off, the input voltage Vᵢₙ becomes equal to the cases in FIGS. 1 and 2.

Thus, the first threshold voltage V_{iH}′, the second threshold voltage V_{iL}′ and the divided voltage V_{div} are set lower than the input voltage Vᵢₙ, thereby enabling the input voltage Vᵢₙ to be used as the power source voltage of the control circuit 22.

### Third Embodiment

Although the capacitance value on the input side of the DC-DC converter is increased stepwise according to the first and second embodiments, a capacitance on an output side of the DC-DC converter is varied stepwise in a third embodiment in addition to the foregoing stepwise increase.

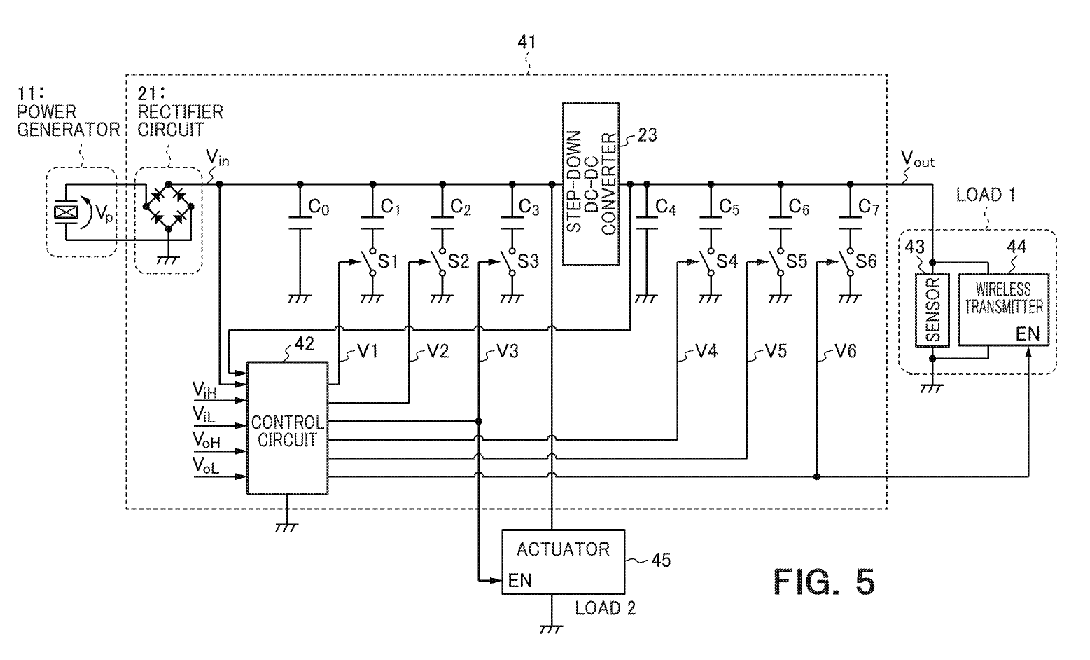

FIG. 5 illustrates a circuit diagram of the power supply device according to the third embodiment. The description will be focused on differences from FIG. 1.

A power supply circuit 41 includes, in addition to the components of the first embodiment, capacitors C₄, C₅, C₆, C₇, and switches S4, S5, S6 on the output side of the DC-DC converter 23.

The capacitor C₄ is connected between the output terminal of the DC-DC converter 23 and the ground terminal. The capacitors C₅-C₇ are respectively connected in parallel to the capacitor C₄. One ends of the capacitors C₅-C₇ are electrically connected to the output terminal of the DC-DC converter 23 and to the load 1, respectively. The other ends of the capacitors C₅-C₇ are connected the ground terminals via the switches S4-S6. It is assumed that the capacitors C₄-C₇ have the same capacitance.

The switches S4-S6 are controlled by control voltages V4-V6 supplied from a control circuit 42. When the control voltages V4, V5, V6 are Low, the switches S4, S5, S6 are off. When the control voltages V4, V5, V6 are High, the switches S4, S5, S6 are on. The use and non-use of the capacitors C₅-C₇ are changed over by switching over the on/off states of these switches S4-S6. As a result, the capacitance values on the output side of the DC-DC converter 23, i.e., the capacitance values between the input terminal of the DC-DC converter 23 and the ground terminals are changed over.

The control circuit 42 monitors an output voltage Vₒᵤₜ of the DC-DC converter 23. The control circuit 42 compares the output voltage Vₒᵤₜ with a third threshold voltage V_{oH} and a fourth threshold voltage V_{oL}, which are supplied from an external circuit. The control circuit 42 generates the control voltages V4, V5, V6 on the basis of comparative results. To be specific, the control circuit 42 sequentially sets on the control voltages V4, V5, V6 each time the output voltage Vₒᵤₜ reaches the third threshold voltage V_{oH}. In other words, the control circuit 42 sequentially turns on the switches S4-S6 each time the output voltage Vₒᵤₜ reaches the third threshold voltage V_{oH}. The control circuit 42 turns all of the switches S4-S6 off when the output voltage Vₒᵤₜ becomes smaller than the fourth threshold voltage V_{oL}.

Herein, the third threshold voltage V_{oH} is higher than the fourth threshold voltage V_{oL}. The third threshold voltage V_{oH} corresponds to an operation voltage of the load 1. The fourth threshold voltage V_{oL} is a value equal to or larger than the lowest operation voltage of the load 1.

The control circuit 42 compares, in the same way as in the first embodiment, the input voltage Vᵢₙ with the first threshold voltage V_{iH} and the second threshold voltage V_{iL}, and outputs the control voltages V1, V2, V3 on the basis of the comparative results. However, the control circuit 42 keeps Low the control voltages V1, V2, V3 (keeps off the switches S1-S3) until turning on all of the switches S4-S6, i.e., until setting High all of the control voltages V4-V6. The control circuit 42 may determine a timing for setting High the control voltage V1 on condition not only that the input voltage Vᵢₙ reaches the first threshold voltage V_{iH} but also that the output voltage Vₒᵤₜ reaches the third threshold voltage V_{oH}.

The load 1 according to the third embodiment includes a sensor 43 and a wireless transmitter 44. The wireless transmitter 44 has an enable terminal EN, and the same control voltage V6 as in the case of the switch S6 is inputted to the enable terminal EN. The wireless transmitter 44 is supplied with the output voltage Vₒᵤₜ of the DC-DC converter 23, and operates upon inputting the control voltage V6 taking the High level to the enable terminal EN. On the other hand, the sensor 43 operates by being supplied with the output voltage Vₒᵤₜ of the DC-DC converter 23. The sensor 43 is smaller in power consumption that the wireless transmitter 44. The wireless transmitter 44 wirelessly transmits data measured by the sensor 43.

A load 2 operating at a high voltage (a voltage before the step-down) is connected between the input terminal of the DC-DC converter 23 and the ground terminal. The load 2 is herein an actuator 45 using the piezoelectric element. A vibrator is instanced as a specific example of the actuator 45. The load 2 includes the enable terminal EN. The same control voltage V3 as in the case of the switch S3 is inputted to the enable terminal EN. The load 2 operates when the pre-stepping down voltage of the DC-DC converter 23 is inputted and when the High control voltage V3 is inputted to the enable terminal EN. In other words, the load 2 starts operating at the timing when the switch S3 is turned on. The load 23 starts operating after the sufficient energy is thereby accumulated in the capacitance on the input side of the DC-DC converter 23.

Note that a modified example may involve supplying a signal (enable signal) taking the high level to the enable terminal EN of the load 2 at a timing with an elapse of a certain period of time since the timing for turning on the switch S3. For example, next, the enable signal may be supplied to the enable terminal EN of the load 2 at the timing when the input voltage Vᵢₙ exceeds the first threshold voltage V_{iH} or a separately determined threshold voltage. The load 2 is thereby enabled to start operating after accumulating a much larger amount of energy in the capacitance of the input side of the DC-DC converter 23.

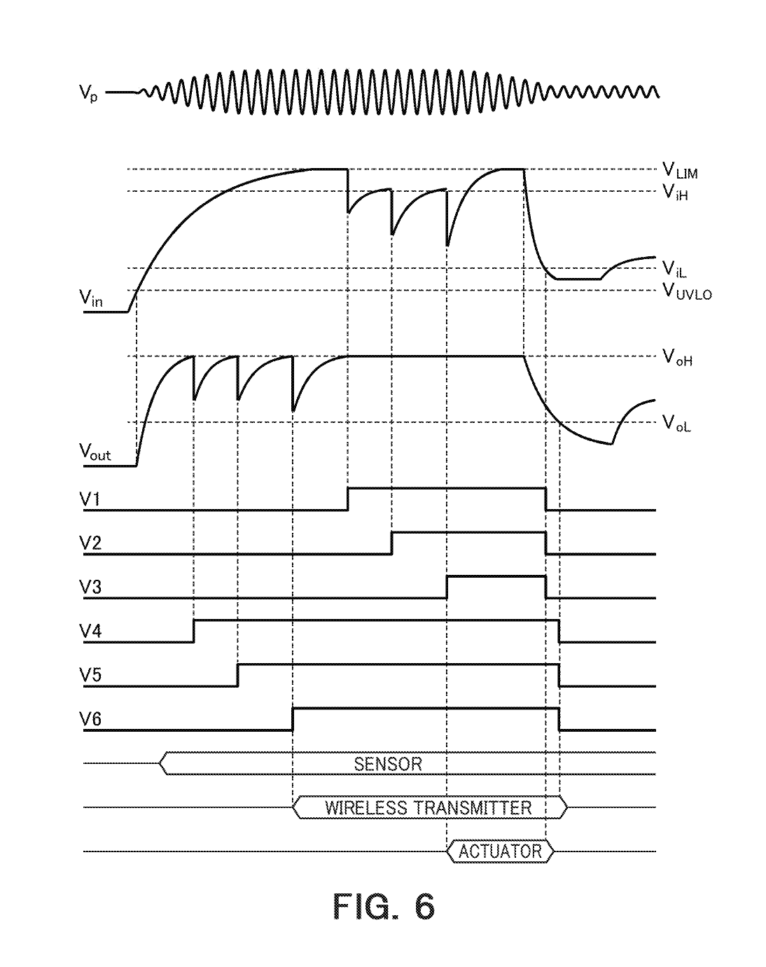

FIG. 6 illustrates operation waveforms of the generation voltage Vₚ, the input voltage Vᵢₙ, the output voltage Vₒᵤₜ and the control voltages V1, V2, V3, V4, V5, V6, and operation timings of the sensor 43, the wireless transmitter 44 and the actuator 45. Note that, in this example, the value of the input voltage Vᵢₙ is limited to V_{LIM} by the Zener diode used in the second embodiment.

The charging voltages of the capacitors C₀-C₇ are “0” before the power generator 11 starts generating the power. At this time, the switches S1-S6 are all off.

When the power generator 11 starts generating the power and generates the generation voltage Vₚ, the capacitor C₀ is charged with the electricity. When the input voltage Vᵢₙ reaches the lowest operation voltage V_{UVLO} of the DC-DC converter 23, the DC-DC converter 23 starts operating, and the output voltage Vₒᵤₜ of the DC-DC converter 23 rises. The sensor 43 included in the load 1 starts operating concomitantly with the rise of the output voltage Vₒᵤₜ.

Each time the output voltage Vₒᵤₜ reaches the third threshold voltage V_{oH}, the control circuit 42 sequentially sets High the control voltages V4-V6. The switches S4-S6 are thereby sequentially turned on, and the capacitors C₅-C₇ are sequentially connected in parallel to the capacitor C₄.

The wireless transmitter 44 operates when the enable signal EN (the control voltage V6) is High. Accordingly, the wireless transmitter 44 starts operating at the timing when the control voltage V6 becomes High.

Thus, according to the third embodiment, the capacitance value on the output side of the DC-DC converter 23 is increased stepwise. Hence, the output voltage Vₒᵤₜ rises fast, thereby enabling the sensor 43 to operate at an early stage. It is also feasible to restrain small the variation of the output voltage Vₒᵤₜ, which is concomitant with the variation of the load power, by operating the wireless transmitter 44 requiring the large power consumption after the capacitance value has increased (when the switch S6 is turned on), and the load 1 can be stably operated.

After the switches S4-S6 have been all turned on, the input voltage Vᵢₙ of the DC-DC converter 23 exceeds the first threshold voltage V_{iH}, and the output voltage Vₒᵤₜ reaches the third threshold voltage V_{oH}, in which case the control circuit 42 sets High the control voltage V1 and turns on the switch S1. Hereafter, the control circuit 42 sequentially sets High the control voltages V2, V3 each time the input voltage Vᵢₙ exceeds the first threshold voltage similarly to the first and second embodiments.

The load 2 (the actuator 45) operates when the enable signal EN (the control voltage V3) is High. Accordingly, the load 2 starts operating at the timing when the control voltage V3 becomes High.

When the generation voltage of the power generator 11 drops down and when the input voltage Vᵢₙ drops under the second threshold voltage V_{iL}, the control circuit 42 sets Low all of the control voltages V1-V3, whereby the switches S1-S3 are turned off. The actuator 45 stops operating because of the control voltage V3 becoming Low.

When the output voltage Vₒᵤₜ drops under the fourth threshold voltage V_{oL}, the control circuit 42 sets Low all of the control voltages V4-V6, whereby the switches S4-S6 are turned off. The wireless transmitter 44 included by the load 1 stops operating because of the control voltage V6 becoming Low. The sensor 43 is kept operating by the accumulated electric charges of the capacitor C₄.

The same relationship as given in the Mathematical Expression (4) used in the first embodiment can be applied to the capacitors C₄-C₇ on the output side in the third embodiment. In this case, it may be sufficient that the lowest operation voltage V_{UVLO} of the DC-DC converter 23 is replaced by the lowest operation voltage of the load 1, and the first threshold voltage V_{iH} is replaced by the third threshold voltage V_{oH}.

Thus, the control voltages V6, V3 used for turning on/off the switches S6, S3 (switching the connection of capacitors C₇, C₃) are employed as the enable signals of the loads 1 and 2, thereby enabling a plurality of loads to be prioritized. Specifically, the sensor 43, the wireless transmitter 44 and the actuator 45 can be controlled to be started up in this sequence.

The capacitance value on the output side of the DC-DC converter 23 is increased stepwise, it is thereby possible to restrain the variation of the output voltage Vₒᵤₜ, which is concomitant with the variation of the load power, when both of the sensor 43 and the wireless transmitter 44 operate.

Further, after the capacitance value on the output side of the DC-DC converter 23 has reached the value necessary for restraining the variation of the output voltage Vₒᵤₜ, the stable operation of the load 1 is assured by starting the increase in capacitance value on the input side of the DC-DC converter 23, whereby extra energy generated by the power generator 11 can be accumulated.

The voltages (voltages to be fed back to the control circuit 42), which are to be observed in the third embodiment, are only the two voltages, i.e., the input voltage Vᵢₙ and the output voltage Vₒᵤₜ, and hence a circuit scale and the power consumption of the control circuit can be restrained to a small level.

Note that the energy accumulated in the capacitor is proportional to a square of the charging voltage, and it is therefore desirable that the extra energy generated by the power generator 11 is accumulated at the high voltage. Accordingly, the capacitance on the output side of the DC-DC converter 23 is set to a sufficient value required for restraining the variation of the output voltage Vₒᵤₜ, and it is preferable that a largest possible number of capacitances are disposed on the input side of the DC-DC converter 23.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A power supply circuit comprising:
a first capacitor configured to accumulate an electric charge corresponding to an input voltage;
an n-number of second capacitors configured to be connected in parallel to the first capacitor, n being an integer equal to or larger than 1);
an n-number of switches configured to be respectively connected in series to the n-number of second capacitors;
a DC-DC converter configured to step down the input voltage; and
a control circuit configured to perform control to sequentially turn on the switches each time the input voltage reaches a first threshold voltage.

2. The power supply circuit according to claim 1, wherein a capacitance value Cᵢ₊₁ of the (i+1)th second capacitor is set to satisfy the following mathematical expression:
$${C}_{i + 1} < {\sum }_{j = 0}^{i} {C}_{j} \frac{{V}_{iH} - {V}_{UVLO}}{{V}_{UVLO}}$$
where V_{iH} is the first threshold voltage, and V_{UVLO} is a lowest operation voltage of the DC-DC converter.

3. The power supply circuit according to claim 1, further comprising a constant voltage circuit configured to restrict the input voltage to a predetermined upper limit value.

4. The power supply circuit according to claim 1, wherein the control circuit operates by the input voltage used as a power source, and
the control circuit includes a plurality of resistances configured to divide the input voltage, and performs control to sequentially turn on the switches each time a divided voltage reaches the first threshold voltage.

5. The power supply circuit according to claim 1, wherein the control circuit turns off all the n-number of switches when the input voltage drops under a second threshold voltage, and
the second threshold voltage is lower than the first threshold voltage and is equal to or larger than the lowest operation voltage of the DC-DC converter.

6. The power supply circuit according to claim 1, further comprising:
a third capacitor configured to be connected to an output terminal of the DC-DC converter;
an m-number of fourth capacitors configured to be connected respectively in parallel to the third capacitor, m being an integer equal to or larger than 1; and
an m-number of switches configured to be connected respectively in series to the m-number of fourth capacitors,
the control circuit performs control to sequentially turn on the switches each time the output voltage reaches the third threshold voltage.

7. The power supply circuit according to claim 6, wherein the control circuit keeps the n-number of switches off until turning on all of the m-number of switches.

8. The power supply circuit according to claim 7, wherein an output voltage of the DC-DC converter is supplied to a first load,
the input voltage is supplied to a second load, and
the control circuit outputs an enable signal for the second load at a timing of outputting a signal to turn on a predetermined switch in the n-number of switches or at a later timing.

9. A power supply device comprising:
a power generator configured to generate a voltage; and
the power supply circuit of claim 1,
wherein the power supply circuit is configured to receive the input voltage being the voltage generated by the power generator.

10. The power supply device according to claim 9, wherein the voltage generated by the power generator is an alternate current voltage,
the power supply circuit includes a rectifier circuit configured to convert the alternate current voltage into a direct current voltage, and
the input voltage is the direct current voltage into which the alternate current voltage is converted by the rectifier circuit.
